(19) United States
(12) Patent Application Publication
(10) Pub. No.: US 2003/0046249 A1
(43) Pub. Date: Mar. 6, 2003

(54) Prepaid card terminal and method for implementing prepaid cards

(76) Inventor: Robert Wu, Princeton Junction, NJ (US)

Correspondence Address: Allen R. Kipnes, WATOV & KIPNES, P.C., P.O. BOX 247, PRINCETON JUNCTION, NJ, 08550, US

(21) Appl. No.: 09/944,269

(22) Filed: Aug. 31, 2001

(51) Int. Cl. G06F 17/60

(52) U.S. Cl. 705/79

(57) ABSTRACT

A prepaid card terminal connected via a global communications network to a remote central server adapted to store and maintain account data associated with a prepaid card where the prepaid card terminal comprises a microcontroller for executing preprogrammed instructions and generating directives, input means electrically connected and responsive to the microcontroller for enabling a customer to input information including prepayment amount in connection with the prepaid card and generating an information signal to the microcontroller, a currency acceptor electrically connected and responsive to the microcontroller for accepting currency from the customer to pay the prepayment amount, and generating a currency accepted signal to the microcontroller upon paying the prepayment amount, output means electrically connected and responsive to the microcontroller for prompting the customer to input the information, and a network interface device electrically connected and responsive to the microcontroller for interfacing with the global communications network to connect to the remote central server.

### FIELD OF THE INVENTION

The present invention relates to prepaid cards, and more particularly to prepaid card terminals and methods for implementing prepaid cards to use for obtaining goods and services.

### BACKGROUND OF THE INVENTION

Prepaid debit instruments are generally well known. Prepaid remote memory telephone calling cards are particularly prevalent in a variety of forms, including promotional brochures, wallet-sized cardboard and plastic cards, and the like.

A prepaid telephone card, for example, typically has printed thereon information necessary to effect telephone calls. In particular, a typical prepaid telephone card includes an access telephone number, for example an 800 number, used to access the prepaid calling system. The card also includes a unique authentication code or ID code which is used to access a particular account. The account record is usually stored in a remote database maintained by the prepaid calling card service provider. Finally, the card includes instructions for placing the telephone call, whether domestic or international.

Such prepaid cards are typically sold in predetermined denominations, for example $5, $10, $20, $50, and the like. Moreover, such cards are often sold at convenience stores and other retail outlets, similar to the way lottery tickets are sold. Card issuers typically provide merchants with batches of cards but do not activate a particular card until the card is actually sold, at which time the merchant incurs a payment obligation. By placing these cards in the possession of the merchant prior to receipt of payment from the merchant, however, the issuer runs the risk of merchant fraud or loss due to theft, for example.

Accordingly, in an effort to minimize the opportunity for fraud and reduce overall transaction costs, there is a need for a prepaid card terminal capable of implementing prepaid cards which may be used for accessing prepaid services such as telephone calls, facsimile transmissions, Internet access and the like. There is further a need for a prepaid card terminal which can instantly activate the prepaid card concurrently with the dispensing of the prepaid card to a customer. In this manner, the lag time prior to usage of the prepaid card is eliminated or at least substantially reduced. In addition, there is a need for a prepaid card terminal which provides the customer with the option to replenish the prepaid balance amount on the prepaid card upon tendering of an appropriate currency payment, thus avoiding residual balance loss typically associated with single-use prepaid debit cards such as prepaid telephone calling cards.

### SUMMARY OF THE INVENTION

The present invention is generally directed to a prepaid card terminal for implementing prepaid cards, or similar items, in which the customer can pre-purchase prepayment or debit amounts in advance for telecommunications access service, for example. Upon the purchase or replenishment of the prepaid card, the prepaid card terminal communicates with a central billing server storing balance information of the prepaid card by transmitting thereto the personal identification number (PIN) associated with the prepaid card, and the prepayment or debit amount deposited by the customer. The central billing server updates the balance amount record and transmits a confirmation message to the terminal for display to the customer. The central billing server provides a central point of access from which all participating point of service terminals and vendors can secure payment for customer's purchase charges. Upon completion of the purchase or replenishment transaction, the terminal informs the customer of the prepayment or debit amount deposited and the corresponding balance amount remaining on the prepaid card.

For new purchases of prepaid cards, the terminal is optionally equipped with a prepaid card dispenser for dispensing a prepaid card to the customer. The terminal then transmits to the central billing server a preassigned PIN for requesting activation of the prepaid card. Upon activation, the prepaid card may be used by the customer with minimal delay. The activation process forgoes the need to maintain an inventory of prepaid cards with activated PINs by activating the prepaid card only upon an actual purchase. This process significantly reduces the appeal of the terminal equipped with the prepaid card dispenser as a potential target of theft.

In one aspect of the present invention, there is provided a prepaid card terminal connected via a global communications network to a remote central server adapted to store and maintain account data associated with a prepaid card where the terminal comprises:

a microcontroller for executing preprogrammed instructions and generating directives;

input means electrically connected and responsive to the microcontroller for enabling a customer to input information including prepayment amount in connection with the prepaid card and generating an information signal to the microcontroller;

a currency acceptor electrically connected and responsive to the microcontroller for accepting currency from the customer to pay the prepayment amount, and generating a currency accepted signal to the microcontroller upon paying the prepayment amount;

output means electrically connected and responsive to the microcontroller for prompting the customer to input the information; and

a network interface device electrically connected and responsive to the microcontroller for interfacing with the global communications network to connect to the remote central server, whereupon receiving the currency accepted signal and the information signal, the microcontroller is programmed to transmit the customer inputted information including the prepayment amount through the global communications network to the remote central server for updating the account data.

In another aspect of the present invention, there is provided a method for enabling a customer to perform a prepay transaction in connection with a prepaid card, wherein the method comprises the steps of:

identifying the prepaid card;

requesting the customer to select a prepayment amount; and

accepting payment from the customer to pay for the prepayment amount selected;

transmitting the identification of the prepaid card and the prepayment amount selected to a remote central server adapted for storing and maintaining account data including a balance amount, associated with the prepaid card via a global communications network; and

adding the prepayment amount selected to the balance amount on the remote central server.

### BRIEF DESCRIPTION OF THE DRAWINGS

The following drawings in which like reference characters indicate like parts are illustrative of embodiments of the invention and are not to be construed as limiting the invention as encompassed by the claims forming part of the application.

FIG. 1 is an elevational view of a prepaid card terminal adapted for connection to a remote central server via global communications network for one embodiment of the present invention; and

FIG. 2 is a schematic diagram of a communications network configured for supporting the prepaid card terminal of FIG. 1 in accordance with the present invention.

### DETAILED DESCRIPTION OF THE INVENTION

The present invention is directed to a prepaid card terminal for implementing prepaid cards purchased by customers. The prepaid card terminal is connected to a remote central server via a global communication network. The remote central server includes a database for storing account data associated with each prepaid card. The prepaid cards may include an indicia such as a personal identification number printed or stored thereon related to the account data associated with the prepaid card. The prepaid card terminal may optionally include a prepaid card dispenser device with a supply of prepaid cards for distribution to new customers. The account data associated with the supply of prepaid cards remain inactivated until purchase by the customer. Upon purchase the prepaid card terminal transmits instructions to the remote central server to activate the account data associated with the purchased prepaid card. The prepaid card terminal further provides the ability to renew or replenish the balance amount on the prepaid card by accepting currency from the customer and instructing the remote central server to update the account data to reflect new balance amount. The present invention is further directed to a method for implementing prepaid cards to customers.

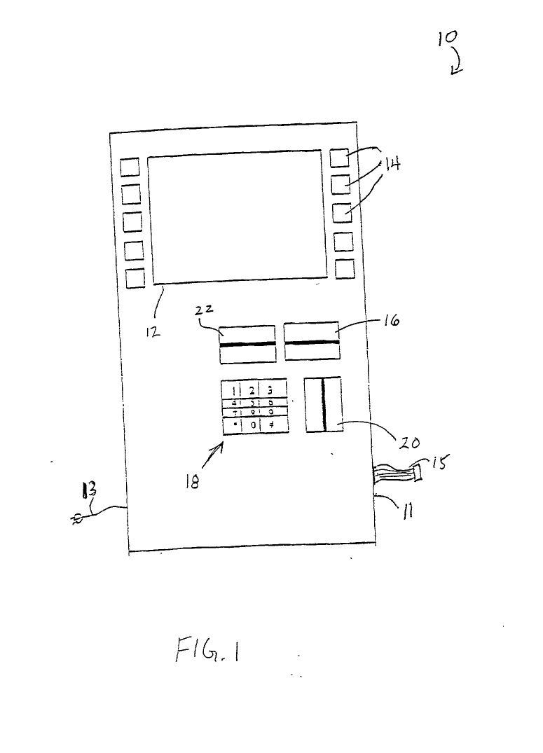

Referring to FIG. 1, a prepaid card terminal 10 adapted for connecting to a remote central server via a global communications network is shown for one embodiment of the present invention. The terminal 10 is adapted to distribute prepaid debit instruments typically in the form of a prepaid card to paying customers on behalf of a card issuer or a prepaid service provider and replenish balance amounts on the prepaid cards. The terminal 10 can be located anywhere such as in convenience stores, malls, etc., so that any customer can simply walk up to the terminal 10 and conveniently purchase a prepaid card. Upon purchase of a new prepaid card, the terminal 10 transmits to a remote central server located remotely therefrom, a personal identification number (PIN) preassigned to the purchased prepaid card along with a prepayment or debit amount deposited, if any, to activate the prepaid card for immediate use.

The terminal 10 is connected to the remotely located central server through a broadband communications channel for a continuous high data transmission. Each prepaid card is associated with a balance amount from which charges made by the customer for goods or services obtained may be deducted by participating point of service terminals or vendors. The balance amount corresponding to the PIN of the prepaid card, is stored and updated in a database maintained by the remote central server. The database is updated by the remote central server on a continuous basis through instant communication with the terminal 10 and the participating point of service terminals and vendors.

Once the remote central server receives the PIN and prepayment or debit amount information from the terminal 10 for the purchased prepaid card, the remote central server updates the database to reflect the activation of the PIN and remaining balance amount. A confirmation message is returned to the terminal 10 and displayed to the customer. The customer may also have the option to periodically replenish or add additional prepayment or debit amount to the balance amount on the prepaid card through the terminal 10. The PIN of the prepaid card and the currency amount tendered information is transmitted through the broadband communications channel to the remote central server. In response to the information, the remote central server updates the balance amount of the prepaid card accordingly and sends a confirmation message to the customer. In a preferred form of the invention, the terminal 10 is connected to the remotely located central server directly over a dedicated communications channel for continuous connection.

In accordance with a further aspect of the present invention, a prepaid card would suitably include all the information necessary to allow a customer to draw upon the prepaid balance amount for obtaining goods and/or services at participating point of service terminals or vendors. In the context of the present invention set forth herein, the balance amount may be drawn for prepaid telephone or Internet service access, for example. However, it will be appreciated that the present invention is not so limited, for example, virtually any type of prepaid arrangement may be effected through the use of the scheme discussed herein, including prepaid goods and services of any kind. In this regard, the goods may relate to data and information which may be sold or accessed through data networks, telephone networks, or global communications networks such as the Internet.

The prepaid card may be suitably printed thereon a suitable identification code or PIN by which a point of service terminal or vendor may associate with to obtain payment for services or goods granted upon the customer of the prepaid card such as access to a service network operated by a prepaid service provider. The prepaid card may typically include a magnetic strip, an integrated chip, a bar code, or the like, on which the identification code or PIN may be stored or recorded and which can be read by appropriate reader devices. The prepaid customer can obtain goods or services from the participating point of service terminal or vendor by first inputting the ID code or PIN of the prepaid card. The point of service terminal connects with the remote central server to transmit the PIN. The remote central server searches the prepaid card database to determine the balance amount on the prepaid card. If sufficient balance amount is present, the prepaid customer is permitted to proceed with the goods or service transaction such as initiating a telephone call, facsimile transmission, and/or Internet access. If the balance amount is inadequate to cover the transaction, the prepaid customer is notified of the balance amount and requested to replenish the balance amount of the prepaid card by depositing payment.

If the prepaid account has sufficient funds available to permit Internet access, facsimile transmission, and/or telephone calling, for example, from the point of service terminal, the customer enters the information relating to the desired service or goods to be attained, such as the telephone number of the desired call destination, IP address of the server to be accessed, and the like, for example in response to a prompt from the point of service terminal. The customer is permitted access to the desired goods or services as the cost for such goods or services is obtained is deducted from the balance amount of the prepaid card stored on the remote central server of the prepaid service provider. If the balance amount on the prepaid card is prematurely depleted, further sale of the goods or services is suspended until the customer replenishes the balance amount of the prepaid card.

For providing security to the customer, the prepaid card may be further associated with a password code which can be selected or modified by the customer at the time of purchase of the prepaid card or during access to the terminal 10 or one of the participating point of service terminals. The customer-selected password code is transmitted and securely stored in association with the PIN of the prepaid card on the central database in the remote central server maintained by the prepaid service provider. The central database may be adapted to store the PINs and the corresponding customer-selected password codes of the activated prepaid cards separately on the database for added security. Thus, to access services offered by the prepaid service provider (e.g. prepaid telephone and Internet service) or participating point of service terminals or vendor, the customer is prompted to supply both the PIN and the customer selected password code, before providing goods or service transaction access. In this manner, the prepaid customer is protected against use of the prepaid card by unauthorized persons for purchasing goods or services. The prepaid customer may be optionally permitted to change the password code periodically at the terminal 10 or at one of the participating point of service terminals.

If the prepaid card is lost or stolen, a replacement prepaid card may be issued with the same PIN to the rightful prepaid customer. If the prepaid customer forgets the password code, the customer may contact the prepaid service provider to obtain a new one. The prepaid service provider verifies the prepaid customer's identity through conventional verification methods such as requesting personal information known only to the rightful customer. Upon proper verification, the prepaid customer is provided a new password code for immediate use.

It will be understood the prepaid card may include a local memory component. For example, information regarding balance amount, and perhaps other useful information relating to the account may be stored directly on the prepaid card, for example, in a random access memory module, microprocessor and the like. In such instances, it is preferably to maintain a central database in a remote central server for storing and updating such information. In circumstances where communication is established with the remote central server each time the prepaid card is used, even cards with a local memory component may be effectively “canceled” or “inactivated”, if the prepaid card are determined to be lost or stolen and the corresponding password code is compromised. In this manner, the remote central server would be in position to authorize the use of the prepaid card each time or at least be in a position to prevent any unauthorized use.

Referring back to FIG. 1, the terminal 10 includes a housing 11 within which all of the operating components are securely housed. The terminal 10 further includes a monitor 12 through which information is conveyed to the customer, a plurality of function keys 14, a currency acceptor 16, a numeric keypad 18, a prepaid card reader 20, a prepaid card dispenser 22, and a network interface device (not shown) for connecting the terminal 10 to a communications channel such as ethernet networks, frame relay networks, synchronous optical network (SONET), asynchronous transfer mode (ATM) networks, digital subscriber loop (xDSL) networks, cable networks, satellite link, T1/T3/E1 trunk lines, integrated services digital network (ISDN), and the like. The communications channel is a broadband carrier system for enabling continuous high speed data connection.

The monitor 12 is adapted to display appropriate customer prompts, additional instructions and advertising information. The plurality of function keys 14 are provided to permit the customer to input information concerning the purchase of the prepaid card. Suitable input devices include cursor tracking devices such as a mouse, touch screen devices, keyboards, function keys, selection buttons/switches, and the like. The currency acceptor 16, and the prepaid card reader 20 are conventionally known structures and the function of each in connection with the present invention will be described herein. The prepaid card reader 20 may be adapted to utilize any known card reading techniques including, but not limited to, optical, magnetic, mechanical or electronic means for reading the data contained on the prepaid card. The terminal 10 also includes a power line 13 and a broadband communications line 15 for providing power and to permit the network interface device of the terminal 10 to communicate and connect with authorized remote servers located on the global communications network such as the Internet, respectively, as will be discussed.

The currency acceptor 16 is a standard bank note acceptor, and accepts paper currency in usual denominations such as $1, $2, $5, $10, etc. The currency acceptor 16 may also be configured to accept coins, if desired. The currency acceptor 16 has the capability of identifying and verifying various currency notes, and if equipped, coins, that the customer may insert. The terminal 10 may optionally include a change making capability, and in that case may include a change dispenser (not shown). Alternatively, the currency acceptor 16 may be adapted to dispense change. The change dispenser can be a known design, and can have a capability of dispensing some combination of coins (e.g. dollar coins, quarter dollars, dimes, nickels, and pennies), and/or bills. In this manner, the customer is permitted to choose the desired currency amount for deposit into the balance amount of the prepaid card for flexibility.

The prepaid card dispenser 22 dispenses the prepaid card to the customer. The prepaid card dispenser 22 holds a supply of prepaid cards in a stack, and dispenses them one at a time. It is understood that when the customer already possesses a prepaid card and chooses to replenish the balance amount, the prepaid card dispenser 22 does not dispense a new prepaid card. When the customer desires to purchase a prepaid card from the terminal 10, the customer simply tenders payment in the form a currency such as cash and coin, check, a credit card, a debit card, or the like to the terminal 10 through the currency acceptor 16 in exchange for the prepaid card. The terminal 10 determines the preassigned PIN of the prepaid card which may be read by the prepaid card reader 20 or inputted manually by the customer. The PIN of the dispensed prepaid card is typically not activated, and must be activated by the terminal 10 through a remote central server for immediate use. The remote central server remotely located from the terminal 10, is configured to communicate with the terminal 10 and the participating point of service terminals and vendors and to govern and update the status of each prepaid card including the balance amount thereof. In this manner, the activation, balance amount replenishment/deduction, and maintenance of the prepaid card is centrally executed by the remote central server of the prepaid service provider as will be described hereinafter.

The terminal 10 further includes a memory storage device such as a hard disk drive, and a microcontroller (not shown) comprising a microprocessor, read only memory, random access memory, and other features such as a clock, interrupt control, control logic, power, and connections. The microcontroller is electronically connected via a bus to the network interface device (not shown), the prepaid card reader 20, keypad 18, the monitor 12, the currency acceptor 16, the prepaid card dispenser 22, and the plurality of function keys 14. Additionally, the microcontroller is connected via a bus to a memory device which has stored therein all of the programs required for operation of the terminal 10.

The microprocessor is any suitable central processing unit for executing commands and controlling the terminal 10. The random access memory serves as storage for calculated results, and as stack memory. The read only memory may be configured to store the operating system, fixed data, standard routines, look up tables and the like. In one embodiment of the present invention, the microcontroller comprises an embedded LINUX main board. Particularly, the main board includes a central processing unit, a 32 megabyte flash memory module, a 64 kilobyte dynamic random access memory and interface ports for connection with a network, the monitor 12, the prepaid card reader 20 such as a magnetic card swipe device via a RS232 port, the currency acceptor 16 via a RS232 port, the prepaid card dispenser 22 via a RS232 port, and a 20 gigabyte hard drive device. The microcontroller is preferably equipped with a Linux operating system software such as the Linux Kernel 2.2.17, or any suitable operating system software.

The terminal 10 enables a customer to purchase a prepaid card in exchange for payment which is deposited into the terminal 10. The payment deposited into the terminal 10 typically equals the initial balance amount of the prepaid card and, optionally, a service charge or fee. The customer retrieves the prepaid card dispensed from the prepaid card dispenser 22 of the terminal 10 and uses it to obtain goods and services offered by the participating point of service terminals or vendors.

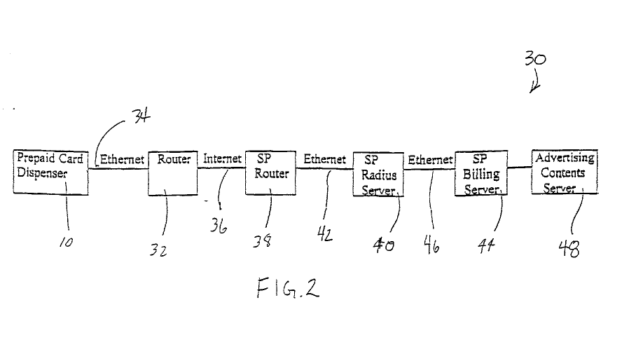

Referring to FIG. 2, a communications network 30 is shown for one embodiment of the present invention for executing the operation of the prepaid card terminal 10. The terminal 10 is connected by the network interface device (not shown) to a router 32 through a broadband network connection 34 such as Ethernet. The router 32 directs communications traffic from the terminal 10 through the global communications network 36 (i.e. Internet) to a prepaid service provider router 38. The prepaid service provider router 38 directs communications traffic to a remote authentication dial-in user service (RADIUS) server 40 maintained by the prepaid service provider and connected thereto through an Ethernet connection 42. The RADIUS server 40 prompts for a username and a password from the terminal 10 for authentication and authorization for access. The information is checked and verified and, if successful, the terminal 10 is permitted access to a central billing server 44 maintained by the prepaid service provider.

The central billing server 44 is adapted for maintaining and updating the account records and statuses of the prepaid cards, and is connected to the RADIUS server 40 via an Ethernet connection 46. The central billing server 44 is connected to an advertising server 48 which stores advertising information for display on the terminal 10 as will be described hereinafter.

With reference to FIGS. 1 and 2, the customer initiates the prepaid card transaction by pressing a designated one of the individual function key pads 14 for obtaining a prepaid card. Responses to the inquiry from the microcontroller will be given by the customer via the plurality of function keys 14. The microcontroller queries the customer to determine if the customer desires to replenish the balance amount of an existing prepaid card or to purchase a new card.

If the customer wishes to replenish an existing prepaid card, the microcontroller prompts the customer to swipe the prepaid card through the prepaid card reader 20 and select the prepayment or debit amount the customer wishes to deposit into the balance amount by pushing the keypad 18. For example, for ten dollars, the customer can push the “1” key and the “0” key, and then can push the “pound” (#) key to add the prepayment or debit amount to the balance amount. If an error is made by the customer in making a selection, the customer may press the “star” (*) to clear. The customer tenders the currency payment into the currency acceptor 16. Alternatively, the customer may pay with a credit card, check card or debit card by swiping it through the prepaid card reader 20. The payment is then withdrawn from the corresponding a credit card, a check card or a debit card through conventional means as known to one of ordinary skill in the art.

The terminal 10 connects to the central billing server 44 upon proper authentication by the RADIUS server 40. Upon authentication, the terminal 10 transmits the PIN and the amount to be added to the balance amount to the central billing server 44. The central billing server 44 updates the balance amount corresponding to the PIN of the prepaid card and returns a confirmation message to the terminal 10 to complete the transaction. Any outstanding balance of money is returned to the customer through the change dispenser (not shown) when the currency amount given is more than the prepayment or debit amount selected by the customer. By permitting the customer to replenish an existing prepaid card, the customer may use the same PIN value and password for accessing services or obtaining goods on a long term basis. This manner of operation significantly reduces the need for a large database memory in the central server 44 used for storing and maintaining the inventory of prepaid card PINs and the corresponding statuses.

If the customer wishes to purchase a new prepaid card, the microcontroller dispenses a new card and prompts the customer to swipe the prepaid card through the prepaid card reader 20. The customer proceeds through the same process as described above in connection with the balance amount replenishment procedure. During connection with the central billing server 44, the terminal 10 transmits the unactivated PIN for activation, and the amount to be added to the balance amount to the central billing server 44. The central billing server 44 activates the PIN and creates an account record including the balance amount for the prepaid card. With the prepaid card activated, the central billing server 44 then sends a confirmation message to the customer to complete the transaction. Any outstanding balance of money is returned to the customer through the change dispenser (not shown) when the currency amount given exceeds the prepayment or debit amount selected by the customer. Optionally, during the purchase of the new prepaid card, the terminal 10 may obtain personal information of the customer such as name, address, and the like, as part of a registration procedure for future verification purposes, and transmit the information to the central billing server 44 for storage in connection with the PIN of the prepaid card.

A request to activate or update the information associated with the prepaid card is initiated by the terminal 10 and ultimately transmitted over the global communications network 36 (i.e. Internet) to the RADIUS server 40 maintained by the prepaid service provider. The RADIUS server 40 authenticates the terminal 10 and enables its access to the central billing server 44. The central billing server 44 updates the balance amount in the account corresponding to the PIN of the prepaid card. The RADIUS server 40 receives confirmation of the transactions from the central billing server 44 and transmits the confirmation to the customer at the terminal 10. The monitor 12 displays the confirmation to indicate that the prepaid card is ready for use and the transaction completed.

The customer may then use the prepaid card for acquiring service or goods from participating service providers or merchants, respectively. The participating service providers and merchants are authorized to access the central billing server 44 to determine the available balance amount corresponding to the prepaid card and, if applicable, deduct the cost for the goods or services furnished to the customer, from the balance amount corresponding to the prepaid card and update the prepaid card record stored in the database of the central billing server 44. The amount owed to the service provider or merchant is recorded and updated for each transaction. To access the central billing server 44, each of the participating service providers and merchants is authenticated by the RADIUS server 40 for each sales transaction to ensure the security of the central billing server 44. On a periodic basis the prepaid service provider pays the service providers and merchants for the amount owed as recorded from the sales transactions with the prepaid card customers purchasing with their prepaid cards.

During periods of inactivity, advertising for other services, or for goods or services of third-parties can be displayed on the monitor 12 to pedestrians and passer-bys. The advertising material is typically stored on the local memory storage device (e.g. hard drive) and retrieved by the microcontroller for periodic display on the monitor 12. To connect to the advertising contents server 48, the terminal 10 must be authenticated by the RADIUS server 40 before access will be permitted. Once authentication is achieved, new advertising material may downloaded from the advertising contents server 48 on a periodic basis for display.

Daily transaction or purchase records are maintained and stored in the central billing server 44 and may be readily retrieved for review and report. The prepaid service provider may access the central billing server 44 through the terminal 10 using the key pad 18 and monitor 12, along with appropriate password protection provided by the RADIUS server 40. Alternatively, the prepaid service provider can access the central billing server 44 from remote locations on the global communications network 36 (i.e. Internet) to review the transaction record of the terminal 10 on a daily, weekly or monthly basis upon proper authentication by the RADIUS server 40. Such access may be made through any suitable communications channel link to the global communications network 36 (i.e. Internet) from any server.

Several hundred cards may be stored in the terminal 10, with the supply replenished on a periodic basis. The prepaid card service provider may periodically check the supply of the cards, collect the revenue accrued by the terminal 10, and maintain the overall operating condition of the terminal 10. If the supply of cards is exhausted, the terminal 10 initiates a refill request and transmits it to the RADIUS server 40 whereby the prepaid service provider is alerted to the supply condition. Alternatively, the terminal 10 may be assigned to and maintained by a third party such as a retailer or merchant. An arrangement can be made where the third party collects and passes the revenues generated by the terminal 10 to the prepaid card service provider in exchange for a service fee. The third party may pass the revenues by depositing it into a bank account where the deposited revenues may be conveniently withdrawn by the prepaid card service provider on a regular basis through suitable means including electronic fund transfer.

The central billing server 44 may also be configured to permit access by the customer through the global communications network 36 (i.e. Internet) upon proper authentication by the RADIUS server 40. The access would be limited only to review of records such as the balance amount and use history or spending history of the prepaid card. The customer only needs to input the PIN and the password of the prepaid card to the RADIUS server 40 for access. In another embodiment, the customer may remotely replenish the balance amount of the prepaid card through the RADIUS server 40 and the central billing server 44 by providing a check card, a credit card or a debit card for payment.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A prepaid card terminal connected via a global communications network to a remote central server adapted to store and maintain account data associated with a prepaid card, said prepaid card terminal comprising:
a microcontroller for executing preprogrammed instructions and generating directives;
input means electrically connected and responsive to the microcontroller for enabling a customer to input information including prepayment amount in connection with the prepaid card and generating an information signal to the microcontroller;
a currency acceptor electrically connected and responsive to the microcontroller for accepting currency from the customer to pay the prepayment amount, and generating a currency accepted signal to the microcontroller upon paying the prepayment amount;
output means electrically connected and responsive to said microcontroller for prompting the customer to input the information; and
a network interface device electrically connected and responsive to said microcontroller for interfacing with the global communications network to connect to the remote central server, whereupon receiving the currency accepted signal and the information signal, said microcontroller is programmed to transmit the customer inputted information including the prepayment amount through the global communications network to the remote central server for updating the account data.

2. The prepaid card terminal of claim 1 wherein the global communications network is the Internet.

3. The prepaid card terminal of claim 2 further comprising a communications channel connecting the network interface device to the Internet.

4. The prepaid card terminal of claim 3 wherein the communications channel is selected from the group consisting of ethernet networks, frame relay networks, synchronous optical network (SONET), asynchronous transfer mode (ATM) networks, digital subscriber loop (xDSL) networks, cable networks, satellite link, T1/T3/E1 trunk lines, integrated services digital network (ISDN), and combinations thereof.

5. The prepaid card terminal of claim 1 wherein the input means is selected from the group consisting of alphanumeric keypads, alpha numeric keyboards, touch screen devices, cursor tracking devices, and function keypads.

6. The prepaid card terminal of claim 1 wherein the prepaid card includes indicia which is related to the account data of the remote central server.

7. The prepaid card terminal of claim 6 wherein the input means further comprises a prepaid card reader for reading the prepaid card indicia.

8. The prepaid card terminal of claim 6 wherein the indicia represents a PIN corresponding to the account data associated with the prepaid card.

9. The prepaid card terminal of claim 1 wherein the output means includes display devices.

10. The prepaid card terminal of claim further comprising a prepaid card dispenser electrically connected and responsive to the microcontroller for dispensing a prepaid card to the customer when a request for a prepaid card is inputted.

11. The prepaid card terminal claim I further comprising a change dispenser electrically connected to the microcontroller for dispensing change when the currency accepted exceeds the prepayment amount.

12. The prepaid card terminal of claim 1 further comprising memory means electrically connected and responsive to the microcontroller for storing advertising information to display on the display device.

13. The prepaid card terminal of claim 1 wherein the currency acceptor includes a note acceptor for accepting paper currency.

14. The prepaid card terminal of claim 13 wherein the currency acceptor includes a coin acceptor for accepting coins and a change dispenser for dispensing coins to the customer when the accepted payment accepted exceeds the prepayment amount.

15. The prepaid card terminal of claim 1 wherein the prepaid card reader is selected from the group consisting of optical scanners, magnetic stripe readers, and microchip readers.

16. The prepaid card terminal of claim 1 wherein the account data includes prepaid balance amount, spending history, and customer-selected password code.

17. A method for enabling a customer to perform a prepay transaction in connection with a prepaid card, said method comprising the steps of:
identifying the prepaid card;
requesting the customer to select a prepayment amount; and
accepting payment from the customer to pay for the prepayment amount selected;
transmitting the identification of the prepaid card and the prepayment amount selected to a remote central server adapted for storing and maintaining account data including a balance amount, associated with the prepaid card via a global communications network; and
adding the prepayment a mount selected to the balance amount on the remote central server.

18. The method of claim 17 further comprising exhibiting advertising information to the customer.

19. The method of claim 17 further comprising dispensing the prepaid card to the customer.

20. The method of claim 17 further comprising requesting customer to select or modify a password code in association with the prepaid card.
